(19) United States
(12) Patent Application Publication
(10) Pub. No.: US 2016/0123570 A1
(43) Pub. Date: May 5, 2016

(54) SOLID-STATE ILLUMINATING APPARATUS HAVING HEAT DISSIPATING STRUCTURE WITH LARGE SURFACE AREA

(71) Applicant: Kenner Material & System Co., Ltd., Taoyuan City (TW)

(72) Inventors: CHENG-CHE TSAI, Taoyuan City (TW); TSUNG-MO HSU, Taoyuan City (TW)

(21) Appl. No.: 14/630,365

(22) Filed: Feb. 24, 2015

(30) Foreign Application Priority Data
Oct. 31, 2014 (TW) 103219409

(51) Int. Cl. F21V 29/77; F21K 99/00; F21V 29/87; F21V 29/89; F21V 29/71

(52) U.S. Cl. CPC F21V 29/773; F21V 29/89; F21V 29/713; F21V 29/87; F21K 9/1355; F21Y 2101/02

(57) ABSTRACT

The present invention provides a solid state illuminating apparatus comprising at least two metal structures with heat dissipating fins, a lamp housing, at least one solid state light emitting device and a driver. The metal structures are configured to stack in the center of the lamp housing. The solid state light emitting device is configured to be located on the metal structure. The driver is configured to be located in the center of the metal structures.

### FIELD OF THE INVENTION

The present invention relates to a solid-state illuminating apparatus and a method for manufacturing a solid-state illuminating apparatus, and more particularly to a solid-state illuminating apparatus having a heat dissipating structure with a large surface area and a method for manufacturing a solid-state illuminating apparatus having a heat dissipating structure with a large surface area.

### DESCRIPTION OF THE PRIOR ART

Solid-state illuminating devices, especially light emitting diodes, which are mainly composed of semiconductor compound materials, provide illumination via combinations of electrons and holes to releases energy in the form of photons through electricity providing semiconductor with energy. Since light emitting diodes have many advantages including fast reaction, relative small volume, low electrical power consumption, low pollution, high reliability, and easy to massive production, light emitting diodes are widely used in many illuminating apparatuses.

Light emitting diodes with high illumination efficiency also generate large amount of heat, and heat dissipation for high power drove light emitting diodes is inevitably a crucial issue to be solved. For example, if light emitting diodes are operated at an elevated temperature, excess and un-dissipated heat accumulated could lead to brightness degradation and life time decrease of light emitting diodes. Thus heat dissipation solution is a critical portion for the design of illuminating apparatuses with light emitting diodes.

Thermally conductive plastic housings are widely used in lately developed illuminating apparatuses with light emitting diodes. In order to increase heat dissipation of light emitting diodes, metal parts such as aluminum parts are usually configured to be positioned under the light emitting diode substrate. Conventionally, the metal parts are integrated into a plastic part or the plastic housing through insert molding. However, the integration or combination between the metal parts and the plastic housing the shape would be seriously affected by the shape complexity of the metal parts. Furthermore, due to the large difference between thermal expansion coefficients of metals and plastics respectively, the plastic housing is likely to create cracks or crazes or ruptures after thermal cyclings. The thermal conductivity of metal depends not only on the thermal conductivity coefficient of the metal, but also on the contact area and surface area of the metal. Larger surface area would provide better heat dissipation performance. Taiwan patent application (publication No. TW 201405067) discloses a heat sink with a metal cylinder integrated into a LED bulb by insert molding. However, the shape and the surface area of the heat sink are limited due to the nature of insert molding process.

Therefore, there is a need to propose a new solid-state illuminating apparatus and a method for manufacturing a solid-state illuminating apparatus to improve heat dissipation of solid-state illuminating apparatus.

### SUMMARY OF THE INVENTION

An object of the present invention is to provide a solid-state illuminating apparatus having a heat dissipating structure with large surface area and a method for manufacturing a solid-state illuminating apparatus having a heat dissipating structure with a large surface area. The specificity of this invention is incorporated extruded metal structure with most economical process and less resource consumption.

According to the object, one embodiment of the present invention provides a solid state illuminating apparatus. The solid state illuminating apparatus comprises at least two metal structures with a plurality of fins, a housing, at least one solid state illuminating device on the metal structures and a driver device for driving the solid state illuminating device located in the center of the metal structures. Each the metal structure has a constant cross sectional profile throughout the metal structure. The metal structures are stacked in the center of the housing after the housing is formed.

Another embodiment of the present invention provides a method for forming a solid state illuminating apparatus, the method comprises the following steps. First of all, at least two metal structures with a plurality of fins are formed by extrusion, wherein each the metal structure has a constant cross sectional profile throughout the metal structure. Then a housing is formed. Next the metal structures are placed in sequence in the center of the housing. Then a driver device for driving the solid state illuminating device is mounted in the center of the metal structures. And at least one solid state illuminating device, like MCPCB is mounted on the metal structures. Finally, the cover is combining with the housing.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention;

FIGS. 1A to 1C show a metal structure 11 with a plurality of fins 11a having a large heat dissipating surface area according to one embodiment of the invention;

FIGS. 1D to 1F show a metal structure 12 with a plurality of fins 12a having a large heat dissipating surface area according to another embodiment of the invention;

FIGS. 1G to 1I show a heat dissipating structure of stacking the metal structures 11 and 12 according to one embodiment of the invention;

FIG. 2 shows a solid state illuminating apparatus according to one embodiment of the invention;

FIG. 3A shows a top view of an integrated housing with inserted metal structures including fins according to one embodiment of the invention;

FIG. 3B shows a cross sectional view of the integrated housing shown in FIG. 3A;

FIG. 3C shows a front view of the housing;

FIG. 3D shows the integrated housing with the inserted metal structures with the fins; and

FIG. 4 shows the relevance between heat input and temperature difference from Tab. 1.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the scale of each component may not be expressly exactly.

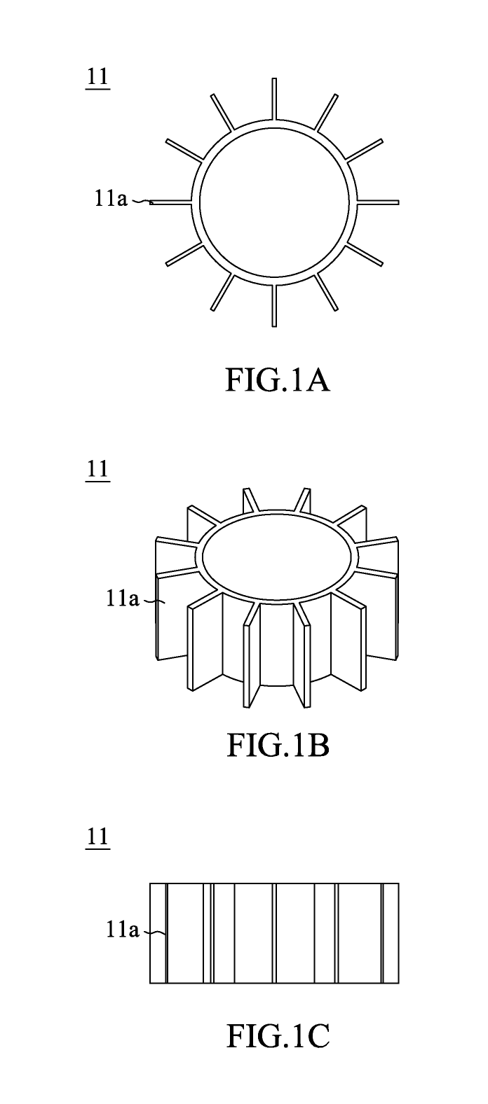

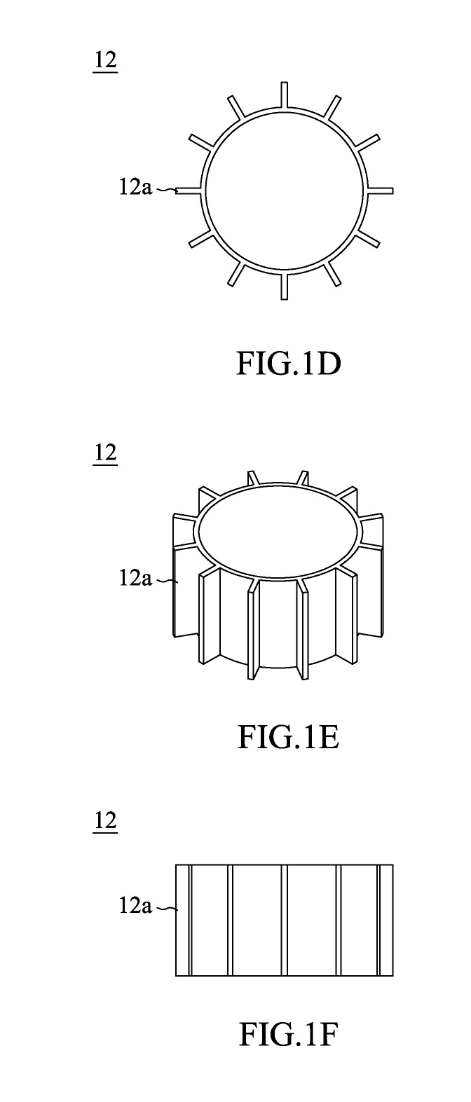

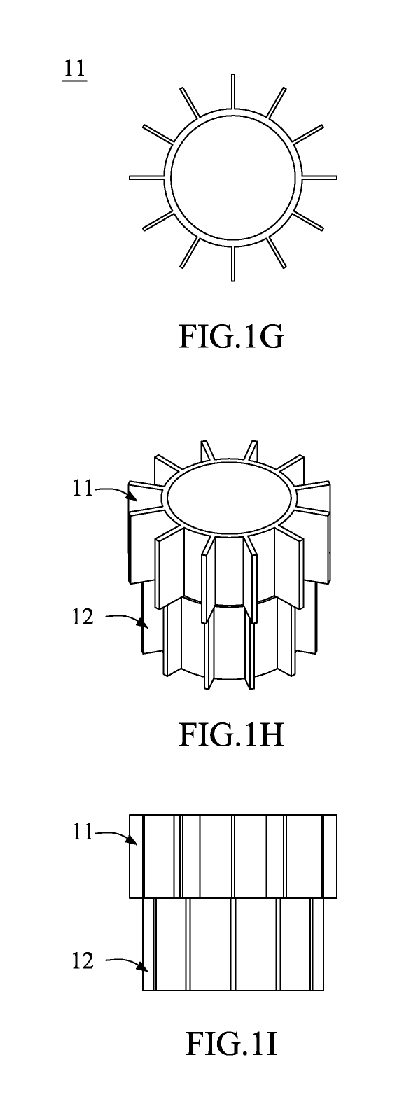

FIGS. 1A to 1C show a metal structure 11 with a plurality of fins 11a having a large heat dissipating surface area according to one embodiment of the invention. FIGS. 1D to 1F show a metal structure 12 with a plurality of fins 12a having a large heat dissipating surface area according to another embodiment of the invention. It is noted that the metal structures 11 and 12 shown in figure are only example. Although the metal structures 11 and 12 are shown as cylinders, the cross sectional profiles of metal structures 11 and 12 can be other geometric shape. The cross sectional area of the metal structure 11 including the fins 11a is larger than the cross sectional area of the metal structure 12 including the fins 12a. In one embodiment, the materials of the metal structures 11 and 12 comprise, but not limited to aluminum. It is noted that the metal structures 11 and 12 are not necessarily made of the same material. The metal structures 11 and 12 with a plurality of fins 11a and 12a are preferably formed by extrusion respectively. Extrusion is a process used to create objects of a fixed cross-sectional profile. A metal material is extruded through a die of the desired cross-section. The major advantage of this process over other manufacturing processes is to create high surface area at relatively low cost. Conventional heat sinks for LED lighting are usually formed by die casting or cold drawing processes. Die casting processes are also able to make produce objects with complex shapes and various cross-sectional profiles while cold drawing processes are not. Comparing to extrusion processes, die casting processes have disadvantages of high cost and cold drawing processes cannot be used to manufacture parts with complex shapes. Extrusion processes have advantages including higher mold design availability and lower resource consumption. Extrusion processes provide better economies of large scale metal parts production.

FIGS. 1G to 1I show a heat dissipating structure of stacking the metal structures 11 and 12 according to one embodiment of the invention, wherein the cross sectional area of the metal structure 11 including the fins 11a is larger than the cross sectional area of the metal structure 12 including the fins 12a so as to fit the cross-sectional profile having a wider portion nearby a cover and a narrower portion toward a head portion of a solid state illuminating apparatus. Nevertheless, the configuration shown in FIGS. 1G to 1I is only an example, not a limitation. The heat dissipating structure comprises at least one metal structure. Moreover, the stacking sequence of the metal structures 11 and 12 can be reversed. Moreover, in one embodiment of the invention, the cross sectional areas of the metal structures 11 and 12 including the fins 11a and 12a are not necessarily different. The cross-sectional profiles of the metal structures 11 and 12 including the fins 11a and 12a depend on the cross-sectional profiles of the solid state illuminating apparatus.

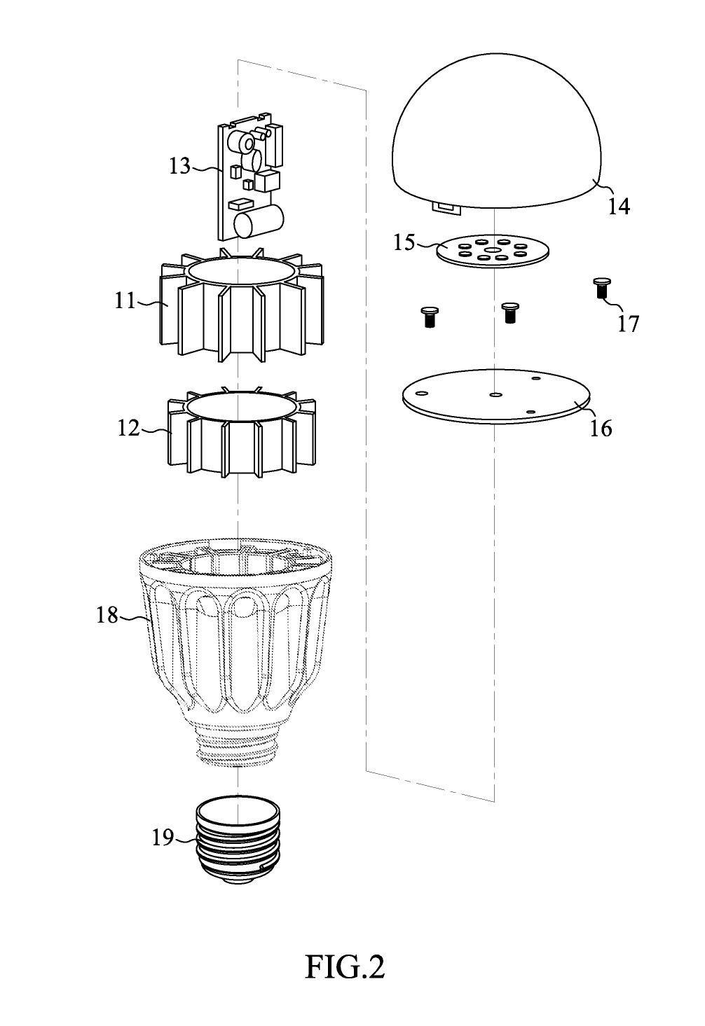

FIG. 2 shows a solid state illuminating apparatus according to one embodiment of the invention. The solid state illuminating apparatus comprises a driver substrate 13, a cover 14, a solid state illuminating device substrate 15, a metal plate 16, metal structures 11 and 12, a housing 18 and a head 19. The cover 14 comprises a bulb cover. Loop portions are on the lower end of the cover 14 for combining with the housing 18. The solid state illuminating device substrate 15 is mounted on the metal plate 16 and can be mounted on the housing 18 by any suitable devices and method, such as using screws 17 to mounting the solid state illuminating device substrate 15 and the metal plate 16 on the housing 18. The solid state illuminating device substrate 15 can be mounted on the metal plate 16 by any suitable devices and method, such as screws. The metal plate 16 contacts with the solid state illuminating device substrate 15 and the lower surface of the metal plate 16 contacts with the metal structure 11 with the fins 11a to constitute a heat conduction path. The driver substrate 13 has driver devices thereon and the driver devices are covered by thermal conductive polymer or polymer materials (not shown).

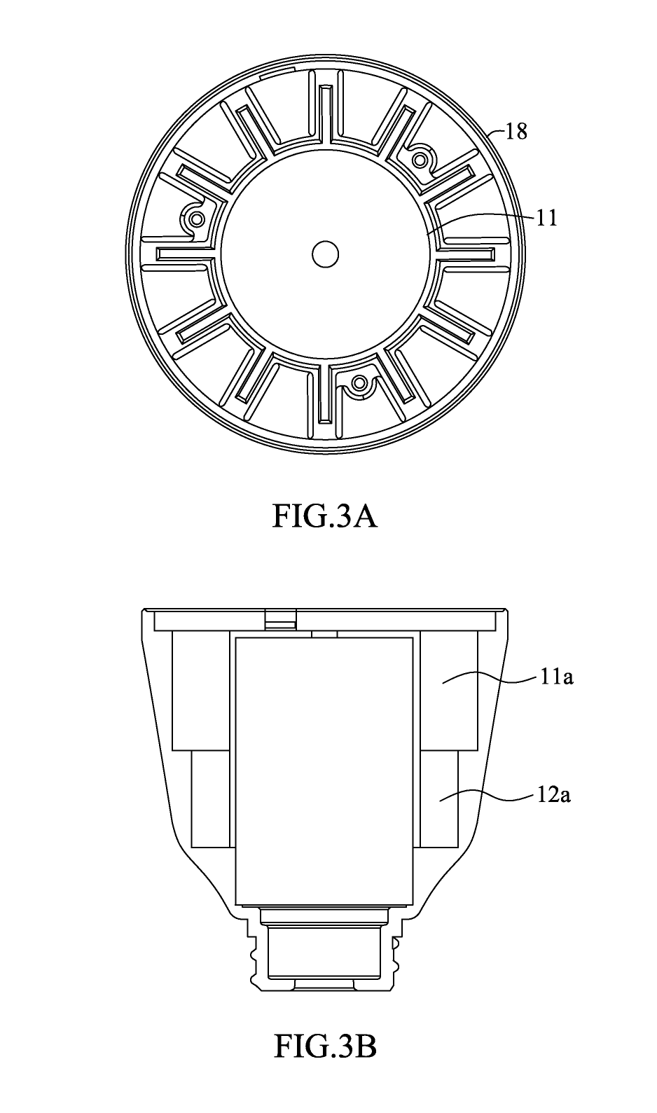

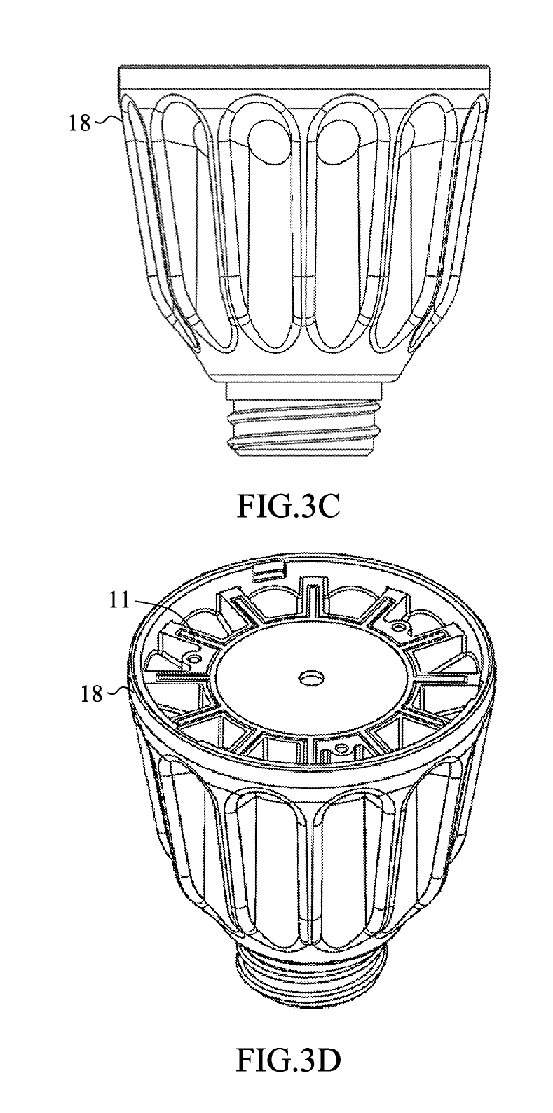

Solid state illuminating devices on the solid state illuminating device substrate 15 comprise light emitting diodes. The metal plate 16 comprises an aluminum plate. The material of the housing 18 comprises thermal conductive polymers with high thermal conductivity coefficients. The material of the housing 18 comprises a thermal conductive plastic which has a thermal conductivity equal or greater than 0.6 W/m-K. The interior of the housing 18 is configured to accommodate the metal structures 11 and 12 including the fins 11a and 12a with fixed cross sectional profiles respectively. A terrace can be formed in the housing 18 to accommodate the stacking metal structures 11 and 12 including the fins 11a and 12a with fixed cross sectional profiles and different cross sectional areas respectively. While the hollow interior of the housing 18 can accommodate the stacking metal structures 11 and 12 having the fins 11a and 12a with large surface areas, the shape of the housing 18 can also be designed for adapting various stacking metal structures having fins with large surface areas and fixed cross sectional profiles. It is noted that the cross sectional profiles of the metal structures and the fins are not limited to a circle and a plate. For example, the cross sectional profiles of the metal structures can be a square, a rectangle, a ellipse, a polygon or any other geometric shape, and the cross sectional profiles of the fins can be a curve, a zigzag line or any other contour line as long as the cross sectional profiles of the metal structures and the fins are constant throughout the metal structures with the fins. A thermal interface material can be formed between the stacking metal structures 11 and 12 having the fins 11a and 12a and the housing 18 to increase the combination and contact area there between. Thus the heat conduction from the solid state illuminating device via the stacking metal structures 11 and 12 to the housing 18 can be improved. The metal structures 11 and 12 are preferably placed into the housing 18 after the housing 18 is formed by any suitable process, such as injection molding. FIG. 3A shows a top view of an integrated housing with inserted metal structures including fins according to one embodiment of the invention while FIG. 3B shows a cross sectional view of the integrated housing shown in FIG. 3A. The portion of the housing nearby the metal structures with the fins and the hollow center of the housing provides electrical insulation and the hollow center of the housing is used to locate a driver substrate. Clips outward are on the top surface of the housing for combining a cover and the housing. FIG. 3C shows a front view of the housing while FIG. 3D shows the integrated housing with the inserted metal structures with the fins.

Driver devices on the driver substrate are located in the center of metal structures and the heat from the driver devices can be transmitted through the metal structures with the fins and a thermal conductive material to the housing and to achieve heat dissipation. The driver devices can be cover by an electrical insulated plastic material. The electrical insulated plastic material comprises thermal polymer materials or flame retarded thermal polymer materials with high thermal conductivity to prevent short circuit between the driver devices and solid state illuminating devices and to improve life time of the solid state illuminating apparatus.

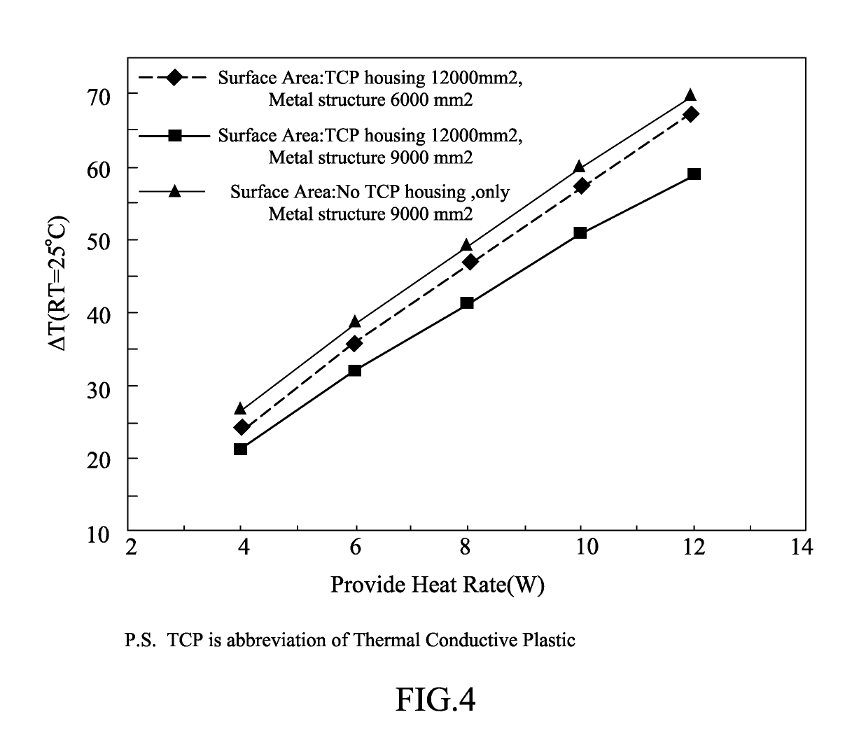

Table 1 and FIG. 4 show the experiment results about temperature difference between interface temperature and ambient temperature, when provide heat input 4 to 12 Watts in metal structures with surface area 6000˜9000 mm². Here the interface temperature is measured between metal plate and heater. And the metal structures are placed into thermal conductive plastic housing or not. A metal structure with larger surface area, when combined with thermal conductive plastic housing shows lower temperature difference. The metal structure with 6000 mm² surface area is only one metal structure with a plurality of fins and placed into thermal conductive plastic housing. The metal structure with 9000 mm² surface area is two metal structures with a plurality of fins stacking and placed into thermal conductive plastic housing. The other metal structure with 9000 mm² surface area is simply two metal structures with a plurality of fins stacking. Comparing heat dissipation effect of metal parts with and without placed into thermal conductive plastic housing, the one with plastic housing shows excellent heat dissipation performance. The stacked metal structures with 9000 mm² surface area and placed into thermal conductive plastic housing can handle the 12 Watts heat input with the interface temperature lower than 90° C. in this invention shows in table 1.

TABLE 1

| | Surface Area (mm²) | | |
|---|---|---|---|
| Thermal Conductive Plastic | 12000 | 12000 | X |
| Housing | | | |
| Inserted Metal Structure | 6000 | 9000 | X |
| Metal Structure | X | X | 9000 |
| Heat Input (W) | ΔT (RT = 25° C.) | | |
| 4 | 24.0 | 20.6 | 26.6 |
| 6 | 35.2 | 31.4 | 38.2 |
| 8 | 46.5 | 40.7 | 48.7 |
| 10 | 56.6 | 50.1 | 59.3 |
| 12 | 66.8 | 58.2 | 69.0 |

Solid state illuminating apparatus of the invention has the following advantages. First of all, the plastic housing has electrical insulation property which can prevent electric shock issues. Moreover, the metal structures are preferably formed by extrusion before being placed into the housing and after the housing 18 is formed so that the metal structures having various shapes each with a constant cross sectional profile throughout the metal structures can be formed and better economies of large scale production as well as low cost can be obtained. Furthermore, multiple heat dissipating metal structures with fins can be stacked to increase total heat dissipating surface area. Since the metal structures are formed by extrusion and are located in the housing by stacking, high cost casting mold is not necessary and large heat dissipating surface area can be obtained. The thermal Interface material between the metal structures and the housing made of thermal conductive polymer material can avoid cracks and crazes on the housing resulting from the difference between the thermal expansion coefficients of the metal structures and the housing respectively.

Although specific embodiments have been illustrated and described, it will be appreciated by those skilled in the art that various modifications may be made without departing from the scope of the present invention, which is intended to be limited solely by the appended claims.

What is claimed is:

1. A solid state illuminating apparatus, comprising:
at least two metal structures with a plurality of fins, wherein each the metal structure has a constant cross sectional profile throughout the metal structure;
a housing, the metal structures being stacked in the center of the housing; and
at least one solid state illuminating device on the metal structures.

2. The apparatus according to claim 1, wherein the metal structures with the fins have different cross sectional areas, and the metal structure having a larger cross sectional area is adjacent the solid state illuminating device.

3. The apparatus according to claim 1, wherein a material of the metal structures with the fins comprises aluminum.

4. The apparatus according to claim 1, wherein the materials of the metal structures with the fins are different.

5. The apparatus according to claim 1 further comprising a thermal conductive material between the metal structures and the housing.

6. The apparatus according to claim 1, wherein the cross sectional profiles of the metal structures comprise a circle, a square, a rectangle, an ellipse and a polygon.

7. The apparatus according to claim 1, wherein the cross sectional profiles of the fins comprise a line, a curve and a zigzag line.

8. The apparatus according to claim 1, wherein the housing has a terrace to accommodate the stacking metal structures.

9. The apparatus according to claim 1, wherein the housing comprises a thermal conductive plastic which has a thermal conductivity equal or greater than 0.6 W/m-K.

10. The apparatus according to claim 1 further comprising:
a cover for combining with the housing;
a solid state illuminating device substrate having the solid state illuminating device thereon and contacting the metal structure;
a metal plate contacting with the solid state illuminating device substrate and having the solid state illuminating device substrate thereon; and
a head on the housing.

11. A method for forming a solid state illuminating apparatus, comprising:
forming at least two metal structures with a plurality of fins by extrusion, wherein each the metal structure has a constant cross sectional profile throughout the metal structure;
forming a housing;
placing the metal structures in sequence in the center of the housing; and
mounting at least one solid state illuminating device on the metal structures

12. The method according to claim 11, wherein the housing is formed by injection molding.

13. The method according to claim 11, wherein the metal structures with the fins have different cross sectional areas, and the metal structure having a larger cross sectional area is adjacent the solid state illuminating device.

14. The method according to claim 11, wherein the cross sectional profiles of the metal structures comprise a circle, a square, a rectangle, an ellipse and a polygon.

15. The method according to claim 11, wherein the cross sectional profiles of the fins comprise a line, a curve and a zigzag line.

16. The method according to claim 11, wherein a material of the metal structures with the fins comprises aluminum.

17. The method according to claim 11, wherein the materials of the metal structures with the fins are different.

18. The method according to claim 11, wherein the metal structure is formed by extrusion.
